(19) United States
(12) Patent Application Publication
(10) Pub. No.: US 2016/0351893 A1
(43) Pub. Date: Dec. 1, 2016

(54) Galvanic Cells and (Partially) Lithiated Lithium Battery Anodes with Increased Capacity and Methods for Producing Synthetic Graphite Intercalation Compounds

(71) Applicant: ROCKWOOD LITHIUM GMBH, Frankfurt/M (DE)

(72) Inventors: Ulrich Wietelmann, Friedrichsdorf (DE); Vera Nickel, Haiger (DE); Stefan Scherer, Griesheim (DE); Ute Emmel, Frankfurt am Main (DE); Thorsten Buhrmester, Darmstadt (DE); Steffen Haber, Bad Soden (DE); Gerd Krämer, Bad Vilbel Germany (DE)

(21) Appl. No.: 15/116,589

(22) PCT Filed: Feb. 13, 2015
(86) PCT No.: PCT/EP2015/053039

§ 371 Date: Aug. 4, 2016

(30) Foreign Application Priority Data
Feb. 13, 2014 (DE) 10 2014 202 656.3

(51) Int. Cl. H01M 4/36; H01M 10/0525; C01B 31/04; H01M 4/587; H01M 4/62; H01M 4/04; H01M 4/1393

(52) U.S. Cl. CPC H01M 4/364; H01M 4/0404; H01M 10/0525; H01M 4/1393; H01M 4/587; H01M 4/622; H01M 4/623; C01B 31/0415; H01M 2004/027

(57) ABSTRACT

The invention relates to a galvanic cell containing a cathode, a lithium-conductive electrolyte separator system, and a synthetic graphite-containing anode. In the manufacture of the cell (i.e. prior to the first charging cycle), the anode contains or consists of a (partially) lithiated graphite powder which is produced from synthetic graphite and lithium powder in a non-electrochemical manner. The invention also relates to a method for (partially) lithiating synthetic graphite in an electroless manner. The invention is characterized in that the particulate synthetic graphite is (partially) lithiated in an electroless manner after mixing with particulate lithium metal powder and by means of a mixing and/or milling process, thereby forming Li graphite intercalates of the composition LiCₓ (mit x=6−600).

Electrochemical cells for lithium ion batteries are as standard constructed in the discharged condition. The advantage of this is that both electrodes are present in an air and water stable form. The electrochemically active lithium is here exclusively introduced in the form of the cathode material. The cathode material contains lithium metal oxides such as for example lithium cobalt oxide (LiCoO₂) as an electrochemically active component. The anode material in the currently commercial batteries contains, in the discharged condition, a graphitic material having a theoretically electrochemical capacity of 372 Ah/kg as the active mass. As a rule, it is completely free of lithium. In future designs, also materials (also free of lithium) having a higher specific capacity may be used, for example alloy anodes, frequently on the basis of silicon or tin.

In real battery systems, part of the lithium introduced with the cathode material is lost as a result of irreversible processes, above all during the first charging/discharging process. Moreover, the classical lithium ion battery design with lithium-free graphite as the anode has the disadvantage that lithium-free potential cathode materials (e.g. MnO₂) cannot be used.

In the case of graphite it is assumed that above all oxygen-containing surface groups react, during the first battery charging process, irreversibly with lithium to form stable salts. This part of the lithium is lost for the subsequent electrochemical charging/discharging processes, because the salts formed are electrochemically inactive. The same applies to the case of alloy anodes, for example silicon or tin anode materials. Oxidic impurities consume lithium according to:

MO₂+4Li→M+2Li₂O (1)
(M=Sn, Si and others)

The lithium bound in the form of Li₂O is no longer electrochemically active. If anode materials having a potential of <approx. 1.5 V are used, a further part of the lithium is irreversibly consumed on the negative electrode for the formation of a passivation layer (so-called solid electrolyte interface, SEI). In the case of graphite, a total of approx. 7 to 20% by weight of the lithium introduced with the positive mass (i.e. the cathode material) are lost in this way. In the case of tin and silicon anodes, these losses are usually even higher. The “remaining” transition metal oxide (for example CoO₂) delithiated according to the following equation (2) cannot, due to a lack of active lithium, make any contribution to the reversible electrochemical capacity of the galvanic cell:

2nLiCoO₂+MOₙ→nLi₂O+M+2nCoO₂ (2)
(M=Si, Sn etc.; n=1 or 2)

There have been many examinations with a view to minimise or completely compensate these irreversible losses of the first charging/discharging cycle. This limitation can be overcome by introducing additional lithium in a metallic form, for example as a stabilised metal powder (“SLMP”) into the battery cell (e.g. US2008283155A1; B. Meyer, F. Cassel, M. Yakovleva, Y. Gao, G. Au, Proc. Power Sourc. Conf. 2008, 43rd, 105-108). However, the disadvantage of this is that the usual methods for producing battery electrodes for lithium ion batteries cannot be carried out. Thus, according to the prior art, passivated lithium reacts with the main air components of oxygen and nitrogen. Although the kinetics of this reaction are very decelerated compared to non-stabilised lithium, however, after prolonged exposure to air, also under dry room conditions, a change in the surfaces and a decrease in metal content cannot be avoided. The extremely vehement reaction of Li metal powder with the solvent N-methyl-pyrrolidone (NMP), which is often used for preparing electrodes, has to be regarded as an even more serious disadvantage. Although significant progress in the direction of a safer handling could be made by providing stabilised or coated lithium powders, however, the stability of the lithium powder stabilised according to the prior art was frequently not sufficient in order to guarantee, under practical conditions, a safe use of passivated lithium powder in the case of NMP-based electrode production methods (suspension methods). Whilst uncoated or deficiently coated metal powders may vehemently react with NMP even at room temperature as early as after a brief induction period (thermal run away), in the case of coated lithium powder this process will occur only at elevated temperatures (for example 30 to 80° C.). Thus, US2008/0283155 describes that the lithium powder coated with phosphoric acid from example 1 reacts extremely vehemently (run away) immediately after mixing them together at 30° C., whereas a powder additionally coated with a wax at 30° C. in NMP will be stable for at least 24 h. The lithium powders coated according to WO2012/052265 are kinetically stable in NMP up to approx. 80° C., however, they decompose exothermically at temperatures beyond that, mostly under phenomena of the run away type. For mainly this reason, the use of lithium powders as a lithium reservoir for lithium ion batteries or for pre-lithiation of electrode materials has so far been commercially unsuccessful.

Alternatively, additional electrochemically active lithium can be introduced into an electrochemical lithium cell also by adding graphite lithium intercalation compounds (LiCₓ) to the anode. Such Li intercalation compounds may be produced either electrochemically or chemically.

The electrochemical production is carried out automatically during charging of conventional lithium ion batteries. As a result of this process, materials with a lithium:carbon stoichiometry of no more than 1:6.0 may be obtained (see e.g. N. Imanishi, “Development of the Carbon Anode in Lithium Ion Batteries”, in: M. Wakihara and O. Yamamoto (ed). in: Lithium Ion Batteries, Wiley-VCH, Weinheim 1998). The partially or fully lithiated material produced in this way can in principle be taken from a charged lithium ion cell under a protective gas atmosphere (argon) and can be used, after appropriate conditioning (washing with suitable solvents and drying), for new battery cells. Due to the extensive efforts associated with this, this approach is chosen only for analytical examination purposes. For economic reasons, this method has no practical relevance.

Further, there are preparative chemical approaches for lithiating graphite materials. It is known that lithium vapour reacts with graphite at a temperature starting from 400° C. to form lithium intercalation compounds (lithium intercalates). However, once 450° C. is exceeded, undesired lithium carbide Li₂C₂ forms. The intercalation reaction works well with highly oriented graphite (HOPG=Highly Oriented Pyrolytic Graphite). If liquid lithium is used, a temperature of just 350° C. is sufficient (R. Yazami, J. Power Sources 43-44 (1993) 39-46). The use of high temperatures is generally unfavourable for energetic reasons. Added to this, in the case of the use of lithium, are the high reactivity and corrosiveness of the alkali metal. Therefore, this production variant is also without any commercial significance.

In the case of the use of extremely high pressures (2 GPa, corresponds to 20,000 atm), lithium intercalation can be achieved even at room temperature (D. Guerard, A. Herold, C. R. Acad. Sci. Ser. C., 275 (1972) 571). Such high pressures can be achieved only in highly specialised hydraulic presses which are suitable only for the production of minute laboratory-scale quantities. This means that this is not an industrially suitable method for producing commercial quantities of lithium graphite intercalation compounds.

Finally, the production of lithiated natural graphite (Ceylon graphite) by means of high energy grinding in a ball mill has been described. To this end, the predominantly hexagonally structured natural graphite from today's Sri Lanka is reacted with lithium powder (170 μm average particle size) in Li:C ratios of 1:6; 1:4 and 1:2. A complete lithiation into the final molar ratio LiC₆ can be achieved only with a molar ratio of 1:2 (R. Janot, D. Guerard, Progr. Mat. Sci. 50 (2005) 1-92). This synthesis variant is also disadvantageous from a technical and commercial point of view. On the one hand, a very high lithium excess is needed in order to achieve a sufficient or complete lithiation. The vast majority of the lithium is lost (in the mill or on the grinding balls) or is not intercalated (i.e. is still present in the elementary form). On the other hand, as a rule no unconditioned natural graphite is used for the production of anodes for lithium ion batteries. The reason is that the mechanical integrity of natural graphite is irreversibly destroyed during battery cycles as a result of so-called exfoliation by the intercalation of solvatised lithium ions (see P. Kurzweil, K. Brandt, “Secondary Batteries-Lithium Rechargeable Systems” in Encyclopaedia of Electrochemical Power Sources, J. Garche (ed.), Elsevier Amsterdam 2009, vol. 5, pages 1-26). Therefore, more stable synthetic graphites are used. Such synthetic graphites are less crystalline and have a lower degree of graphitisation. Finally, the long grinding times of preferably 12 hours (page 29) that are needed for natural graphites are of disadvantage.

For the reasons mentioned above, the method described has never been commercialised.

In the publication by Janot and Guerard as listed above, also the application properties of the lithiated Ceylon graphite are described (chapter 7). Electrode production is carried out by simply pressing the graphite onto a copper network. As a counter and reference electrode, lithium strips are used, as the electrolyte, a 1 M LiClO₄ solution in EC/DMC is used.

The type of electrode preparation by simple pressing on does not correspond to the prior art as applied in commercial battery electrode production. A simple compression without the use of a binder and, if necessary, adding conductivity additives, does not result in stable electrodes since the volume changes occurring during charging/discharging will by necessity lead to crumbling of the electrodes, as a result of which the functionality of the battery cell is destroyed.

The invention is based on the object of indicating a partially or completely lithiated anode graphite for lithium battery cells as well as of providing a lithium cell using said anode graphite, the capacity of which is enhanced by the additional lithium reservoir compared to the prior art.

Further, a method for achieving this object is to be indicated. This method is should

1. be based on low-cost materials available on the market, in particular of synthetic graphites,

2. use the lithium to a high yield, and

3. allow the usual manufacturing methods to be used, i.e. in particular anode manufacturing using solvent-based dispersion casting and coating methods, wherein the use of customary solvents during anode production, e.g. of NMP, is to be possible in a safe manner.

This object is achieved by using a lithium battery cell, the anode of which contains synthetic graphite in powder form, which is partially or completely lithiated prior to the first charging cycle up to the thermodynamically stable maximum stoichiometry LiC₆ (briefly referred to below as “(partially) lithiated”), or which (i.e. the anode) consist thereof, and wherein the lithiation of the synthetic graphite was effected in a non-electrochemical manner under normal pressure or a slight over pressure of <approx. 10 bar.

Synthetic anode graphites are provided by a number of manufacturers including SGL Carbon, Hitachi and Timcal. These products are particularly important for use as anode materials for lithium ion batteries. For example, the synthetic graphite SLP 30 by the Timcal Company consists of particles having an average particle size of 31.5 μm and an irreversible capacity of 43 mAh/g (related to the reversible capacity of 365 mAh/g, this corresponds to approx. 12%) (C. Decaux et al., Electrochim. Acta 86 (2012) 282).

The (partially) lithiated synthetic graphite powders according to the invention are produced by mixing a synthetic graphite in powder form with lithium metal powder and is reacted by stirring, grinding and/or compressing at pressures of <10 bar for forming Li graphite intercalates of the composition LiCₓ (with x=6−600). Depending on the desired final stoichiometry, the two raw materials mentioned are used in a molar ratio Li:C of 1: at least 3 to 1: maximum 600, preferably 1: at least 5 and 1: maximum 600. The lithium introduced via the maximum stoichiometry LiC₆ is presumably present on the graphite surface in a finely dispersed form.

The reaction is carried out in a temperature range between 0 and 180° C., preferably between 20 and 150° C., either in vacuum or under an atmosphere, the components of which react, if at all, only acceptably slowly with metallic lithium and/or lithium graphite intercalation compounds. This is preferably either dry air or an inert gas, particularly preferably argon. The lithiation process is carried out at normal or only moderately enhanced ambient pressures (maximum 10 bar).

The lithium is used in powder form consisting of particles with an average particle size between approx. 5 and 500 μm, preferably between 10 and 200 μm. Both coated powders such as e.g. a stabilised metal powder available from FMC Company (Lectromax powder 100, SLMP) having a lithium content of at least 97% by weight, or for example a powder coated with alloy-forming elements having a metal content of at least 95% by weight (WO2013/104787A1). Particularly preferably, uncoated lithium powders having a metal content of 99% by weight are used. For an application in the battery area, the purity in relation to metallic impurities must be very high. The sodium content, inter alia, must not be >200 ppm. Preferably, the Na content is ≦100 ppm, particularly preferably ≦80 ppm.

As synthetic graphite, all graphite qualities in powder form may be used that are industrially produced and are not procured from natural resources (mines). Starting materials for synthetic graphites are graphitisable carbon carriers such as petroleum coke, needle coke, carbon black, plant waste products etc., as well as graphitisable binders, in particular coal tar pitch or duroplastic synthetic resins. The synthetic graphites used are characterised by average particle sizes in a range of approx. 1 to 200 μm, preferably 10 to 100 μm. The synthetic graphites used have as a rule a lower degree of graphitisation or order (and a lower crystallinity) than typical natural graphites, e.g. the graphite from Ceylon/Sri Lanka. The degree of graphitisation of a graphitic material may also be characterised by taking an exact measurement of the coherent domain diameter Lₐ (i.e. of the in-plane crystallite diameter) by radiographical or (simpler) by Raman-spectroscopic measurements. Graphites have a typical Raman absorption at approx. 1575-1581 cm⁻¹ (“G band”). This absorption is due to in-plane vibrations (E_{2g} G mode) of the sp²-bound carbons of the undisturbed lattice. In the case of polycrystalline or disordered graphites, Raman peaks typically at 1355 cm⁻¹ (A_{1g}) as well as (at a lower intensity) at 1620, 1500 and 1550 cm⁻¹ (so-called “D band”, D=defect) are added. From the signal ratio between the intensities of D band and G band I_{D}:I_{G}, the domain diameter Lₐ may be calculated, which describes the degree of crystallinity and thus the degree of graphitisation (A. C. Ferrari and J. Robertson, Phys. Rev. B, 61(2000) 14095-107; Y.-R. Rhim et al., Carbon 48 (2010) 1012-1024). Graphite with a high degree of crystallinity (HOPG) and well-ordered natural graphites have an I_{D}:I_{G} ratio of 0-approx. 0.3 (W. Guoping et al., Solid State Ionics 176 (2005) 905-909). The natural graphite from Ceylon/Sri Lanka has an I_{D}:I_{G} ratio of approx. 0.1 (corresponding to a domain diameter Lₐ of approx. 40 nm, see M. R. Ammar, Carbon-Amer. Carbon Soc.-print ed. 611-2, 2000). By contrast, synthetic graphites tempered at T<1000° C. have markedly higher I_{D}:I_{G} ratios of typically 1 (corresponds to Lₐ=approx. 4 nm, S. Bhardwaj et al., Carbon Lett. 8 (2007) 285-291). Although it is possible to increase the domain diameter Lₐ by high temperature tempering, however, this process increases the irreversible loss of the first charging/discharging cycles during use as anode material. For this reason, synthetic anode graphites require a surface treatment that improves the electrochemical properties thereof. Thus, it is described for example in WO2013/149807 that a synthetic graphite with Lₐ=40 nm (I_{D}:I_{G}=approx. 0.15) experiences, as a result of a post-treatment with oxygen, a reduction of the Lₐ diameter to 15 nm (I_{D}:I_{G}=approx. 0.39). In the course of this, the irreversible losses drop from 27 to 11.5%.

According to the invention, synthetic graphites are preferred which have an I_{D}:I_{G} ratio of at least 0.2, but particularly preferably at least 0.5 (corresponding to a domain diameter Lₐ of max. 29 nm, particularly preferably max. 12 nm).

The reaction (i.e. the (partial) lithiation) is carried out during mixing or grinding the two components of lithium powder and graphite powder. In the laboratory, grinding can be carried out using a mortar and pestle. Preferably, the reaction is carried out in a mill, for example in a rod, vibration or ball mill. Particularly preferably, the reaction is carried out in a planetary ball mill. On a laboratory scale, for example the planetary ball mill Pulverisette 7 Premium Line by the Fritsch Company may be used for this. If planetary ball mills are used, advantageously very short reaction times of <10 h., frequently even <1 h. can surprisingly be realised.

The mixture of lithium and graphite powder is preferably ground in the dried condition. However, it is also possible to add a fluid, which is inert in respect of both substances, up to a weight ratio of no more than 1:1 (sum Li+C:fluid). The inert fluid is preferably an anhydrous hydrocarbon solvent, e.g. a liquid alkane or alkane mixture or an aromatic solvent. As a result of the addition of solvents, the intensity of the grinding process is attenuated and the graphite particles are less intensively ground.

The grinding duration is a function of different requirements and process parameters:
weight ratio of grinding balls to product mix
type of grinding balls (e.g. hardness and density)
intensity of the grinding (revolution frequency of the grinding plate)
reactivity of the lithium powder (e.g. type of coating)
weight ratio Li:C
product-specific material properties
desired particle size, etc.

The suitable conditions may be found by a person skilled in the art by way of simple optimisation experiments. In general, grinding durations fluctuate between 5 minutes and 24 hours, preferably between 10 minutes and 10 hours.

The synthetic graphite powder (partially) lithiated according to the method described above is still “active” under ambient conditions (air and water) as well as in many functionalised solvents and liquid electrolyte solutions, i.e. it can react over prolonged periods of time, however, as a rule not intensely or even under run away phenomena. When moved to normal air, the contained lithium reacts slowly to form stable salts such as lithium hydroxide, lithium oxide and/or lithium carbonate. This susceptibility can be removed or at least further reduced by means of a coating process. To this end, the (partially) lithiated synthetic graphite powder is reacted (“passivated”) in a suitable manner in a downstream process step with a gaseous or liquid coating agent. Suitable coating agents contain functional groups or molecule moieties that are reactive with metallic lithium as well as lithium graphite intercalation compounds, and therefore react with the lithium available at the surface. A reaction of the lithium-containing surface zone takes place under formation of non- or poorly air-reactive (i.e.

thermodynamically stable) lithium salts (such as e.g. lithium carbonate, lithium fluoride, lithium hydroxide, lithium alcoholates, lithium carboxylates). During this coating process, the majority of the lithium located at the particle surface (e.g. the intercalated part) remains in an active form, i.e. with an electrochemical potential of approx. ≦1 V vs. Li/Li⁺. Such coating agents are known from lithium ion battery technology as in situ film formers (also referred to as SEI formers) for the negative electrode and are described for example in the following review articles: A. Lex-Balducci, W. Henderson, S. Passerini, Electrolytes for Lithium Ion Batteries, in Lithium-Ion Batteries, Advanced Materials and Technologies, X. Yuan, H. Liu and J. Zhang (ed.), CRC Press Boca Raton, 2012, p. 147-196. Suitable coating agents will be listed below by way of example. N₂, CO₂, CO, O₂, N₂O, NO, NO₂, HF, F₂, PF₃, PF_{S}, POF₃ and similar are suitable as gases. Suitable liquid coating agents are for example: carbonic acid esters (e.g. vinylene carbonate (VC), vinyl ethylene carbonate (VEC), ethylene carbonate (EC), propylene carbonate (PC), dimethyl carbonate (DMC), diethyl carbonate (DEC), ethyl methyl carbonate (EMC), fluoroethylene carbonate (FEC)); lithium chelatoborate solutions (e.g. lithium bis(oxalato)borate (LiBOB); lithium bis(salicylato)borate (LiBSB); lithium bis(malonato)borate (LiBMB); lithium difluoro(oxalato)borate (LiDFOB), as solutions in organic solvents, preferably selected from: oxygen-containing heterocycles such as tetrahydrofuran (THF), 2-methyl-tetrahydrofuran (2-methyl-THF), dioxolane, carbonates such as ethylene carbonate, propylene carbonate, dimethyl carbonate, diethyl carbonate and/or ethyl methyl carbonate, nitriles such as acetonitrile, glutarodinitrile, carboxylic acid esters such as ethyl acetate, butyl formate and ketones such as acetone, butanone); sulphur organic compound (e.g. sulfites (vinyl ethylene sulfite, ethylene sulfite, sulfones, sultones and similar); N-containing organic compounds (e.g. pyrrole, pyridine, vinyl pyridine, picoline, 1-vinyl-2-pyrrolidinone), phosphoric acid, organic phosphorus-containing compounds (e.g. vinylphosphonic acid), fluorine-containing organic and inorganic compounds (e.g. partially fluorinated hydrocarbons, PF₃, PF_{S}, LiPF₆, LiBF₄, the two last-mentioned compounds dissolved in aprotic solvents), silicon-containing compounds (e.g. silicone oils, alkyl siloxanes), and others.

The coating not only improves the handling properties and safety during electrode (in general anode) production, but also the application properties in the electrochemical battery cell. The reason is that, when pre-coated anode materials are used, the in situ formation of an SEI (Solid Electrolyte Interface) during contact of the (partially) lithiated graphite anode material with the liquid electrolytes of the battery cells is eliminated. The stabilising coating layer, which is formed outside of the electrochemical cell, corresponds in its properties to a so-called artificial SEI. In an ideal case, the forming process for the electrochemical cell, which is necessary in the prior art, is eliminated or at least simplified.

When using liquid coating agents, the coating process is generally carried out under an inert gas atmosphere (e.g. an argon protective atmosphere) at temperatures between 0 and 150° C. In order to increase the contact between the coating agent and the (partially) lithiated synthetic graphite powder, mixing or stirring conditions are advantageous. The required contact time between the coating agent and the (partially) lithiated synthetic graphite powder is a function of the reactivity of the coating agent, the prevailing temperature and of other process parameters. In general, periods between 1 minute and 24 hours are expedient. The gaseous coating agents are used either in a pure form or preferably in a mixture with a carrier gas, e.g. an inert gas such as argon.

The synthetic graphite powder (partially) lithiated (and optionally pre-coated) according to the method described above can be used for producing battery electrodes. To this end, it is mixed and homogenised, under inert and dry room conditions, with at least one binder material and optionally with one or more further material(s) in powder form, which are capable of intercalating lithium, with an electrochemical potential ≦2 V vs Li/Li⁺, as well as also optionally an additive that improves conductivity (e.g. carbon blacks or nickel powder), as well as an organic solvent, and this dispersion is applied using a coating process (casting process, spin coating or an air brush method) onto a current collector, and is dried. Surprisingly, the (partially) lithiated graphite powder produced using the method according to the invention is only moderately reactive in respect of N-methyl-pyrrolidone (NMP). If highly reactive solvents such as NMP are used, uncoated (partially) lithiated graphite powders with a stoichiometric molar C:Li ratio of at least 6, preferably at least 12 are used. In case of the (partially) lithiated graphite powder stabilised using a coating, also lower-molar C:Li ratios (i.e. higher Li contents) of up to at least 3 may be used. If these restrictions are adhered to, the (partially) lithiated graphite powders may be readily processed with NMP and the binder material PVdF (polyvinylidene difluoride) to form a castable or sprayable dispersion. Alternatively, also the solvents N-ethyl-pyrrolidone, dimethyl sulfoxide, cyclic ethers (e.g. tetrahydrofuran, 2-methyl tetrahydrofuran), ketones (e.g. acetone, butanone) and/or lactones (e.g. γ-butyrolactone) may be used. Further examples of suitable binding materials are: carboxymethyl cellulose (CMC), alginic acid, polyacrylates, Teflon and polyisobutylene (e.g. Oppanol of the BASF Company). If polyisobutylene binders are used, then preferably hydrocarbons (aromatics, e.g. toluene or saturated hydrocarbons, e.g. hexane, cyclohexane, heptane, octane) are preferably used.

The optionally used further material in powder form that is capable of intercalating lithium is preferably selected from the groups including graphites, graphene, layer-structured lithium transition metal nitrides (e.g. Li_{2.6}Co_{0.4}N, LiMoN₂, Li₇MnN₄, Li_{2.7}Fe_{0.3}N), metal powders capable of alloying with lithium (e.g. Sn, Si, Al, Mg, Ca, Zn or mixtures thereof), main group metal oxides with a metal which in a reduced form (i.e. as a metal) alloys with lithium (e.g. SnO₂, SiO₂, SiO, TiO₂), metal hydrides (e.g. MgH₂, LiH, TiNiHₓ, AlH₃, LiAlH₄, LiBH₄, Li₃AlH₆, LiNiH₄, TiH₂, LaNi_{4.25}Mn_{0.75}H₅, Mg₂NiH_{3.7}), lithium amide, lithium imide, tetralithium nitride hydride, black phosphorus as well as transition metal oxides that can react with lithium according to a conversion mechanism under absorption of lithium (e.g. Co₃O₄, CoO, FeO, Fe₂O₃, Mn₂O₃, Mn₃O₄, MnO, MoO₃, MoO₂, CuO, Cu₂O). An overview of anode materials that can be used can be seen from the overview article by X. Zhang et al., Energy & Environ. Sci. 2011, 4, 2682. The anode dispersion produced according to the invention, which contains a (partially) lithiated synthetic graphite powder produced by non-electrochemical means, is applied to a current collector foil preferably consisting of a thin copper or nickel sheet, dried and preferably calendared. The anode foil produced in this way can be combined to a lithium battery with an enhanced capacity compared to the prior art by way of a combination with a lithium-conductive electrolyte separator system and a suitable cathode foil containing a lithium compound with a potential of >2 V vs Li/Li⁺(e.g. lithium metal oxides such as LiCoO₂, LiMn₂O₄, LiNi_{0.5}Mn_{1.5}O₂ or sulfides such as Li₂S, FeS₂). The technical production of such galvanic cells (however without the use of the (partially) lithiated synthetic graphite powders according to the invention) is sufficiently known and described (see e.g. P. Kurzweil, K. Brandt, Secondary Batteries, Lithium Rechargeable Systems: Overview, in: Encyclopaedia of Electrochemical Power Sources, ed. J. Garche, Elsevier, Amsterdam 2009, vol. 5, p. 1-26).

The invention relates in particular:

to a method for producing lithium battery anodes, wherein a (partially) lithiated synthetic graphite in powder form, produced using a non-electrical process, is mixed and homogenised, under inert and dry room conditions, with at least one binder material and optionally one or more further materials in powder form, which are capable of intercalating lithium, with an electrochemical potential ≦2 V vs Li/Li+ and also optionally with an additive improving conductivity as well as with a solvent, and this dispersion is applied to a current collector foil using a coating method, and is dried.

A method, wherein the synthetic graphites have an ID:IG ratio, determined using Raman spectroscopy, of at least 0.2, particularly preferably at least 0.5.

A method, wherein the optionally used further material in powder form, that is capable of intercalating lithium, is preferably selected from the groups including graphites, graphene, layer-structured lithium transition metal nitrides, metal powders capable of alloying with lithium, main group metal oxides with a metal which in a reduced form (i.e. as a metal) alloys with lithium, metal hydrides, lithium amide, lithium imide, tetralithium nitride hydride, black phosphorus as well as transition metal oxides, which can react with lithium according to a conversion mechanism under absorption of lithium.

A method, wherein the non-electrical (partial) lithiation of the synthetic graphite in powder form is carried out after mixing with lithium metal in powder form and is brought about by stirring, grinding and/or compressing under formation of Li graphite intercalates of the composition LiCₓ (with x=6−600).

A method, wherein the molar ratio of the two atom types Li:C is between 1: at least 3 and 1: maximum 600, preferably between 1: at least 5 and 1: maximum 600.

A method, wherein the lithiation process is carried out under an ambient pressure of max. 10 bar.

A method, wherein the lithiation process is carried out in a temperature range between 0 and 180° C.

A method, wherein a coated or preferably an uncoated lithium powder with average particle sizes between 5 and 500 μm is used.

A method, wherein the uncoated lithium metal powder has a purity (i.e. a proportion of metallic lithium) of at least 99% by weight.

A method, wherein the grinding of the lithium powder with the synthetic graphite powder is carried out in a dry condition.

A method, wherein the grinding of the lithium powder with the synthetic graphite powder is carried out in the presence of an inert fluid, wherein the weight proportion of the fluid does not exceed that of the solids (i.e. max. 1:1 w:w).

A method, wherein the Na content of the Li powder is maximum 200 ppm, preferably maximum 100 ppm, particularly preferably maximum 80 ppm.

A method, wherein the synthetic graphite (partially) lithiated in a non-electric manner is coated in a downstream step for improving handling and for further reducing irreversible losses, with substances that are capable of forming an artificial SEI on the graphite surface.

A method, wherein the coating agents are selected from: N₂, CO₂, CO, O₂, N₂O, NO, NO₂, HF, F₂, PF₃, PF₅, POF₃, carbonic acid esters, lithium chelatoborate solutions, sulphur organic compounds, nitrogen-containing organic compounds, phosphoric acid, organic phosphorus-containing compounds, fluorine-containing organic and inorganic compounds, silicon-containing compounds.

The use of the (partially) lithiated graphite powder produced using the method according to the invention as a component/active material of lithium battery electrodes.

A galvanic cell containing a cathode, a lithium-conductive electrolyte separator system and a synthetic-graphite-containing anode, wherein the anode contains or consists of a (partially) lithiated graphite powder produced during the cell production (i.e. prior to the first charging cycle) from synthetic graphite and lithium powder by non-electrochemical means.

A galvanic cell, wherein the synthetic graphite used for the lithiation has an ID:IG ratio, determined by Raman spectroscopy, of at least 0.2, particularly preferably of at least 0.5.

A galvanic cell, wherein the molar ratio between the graphite (C) and electrochemically active lithium (Li) is min. 3:1 and max. 600:1.

### EXAMPLES

### Example 1: Production of LiCₓ (x=approx. 6) from Synthetic Graphite SLP 30 and Uncoated Lithium in a Planetary Ball Mill

Under a protective gas atmosphere (argon-filled glove box), 5.00 g of synthetic is graphite powder SLP30 from the Timcal Company as well as 0.529 g of uncoated lithium powder with an average particle size of D₅₀=123 μm (measurement method: laser reflection, device Lasentec FBRM of the Mettler Toledo Company) are filled into a 50-ml grinding cup from zirconium oxide and mixed using a spatula. Subsequently, approx. 27 g of zirconium oxide grinding balls (ball diameter 3 mm) were filled in. The mixture was ground in a planetary ball mill (Pulverisette 7 Premium Line of the Fritsch Company) for 15 minutes at a rotation frequency of 800 rpm.

The ground product was screened in the glove box, and 4.6 g of a black, gold-glimmering and pourable powder were obtained.

It can be shown using X-ray diffraction analysis that a unitary product with a stoichiometry of C: intercalated Li of approx. 12:1 has formed. Metallic lithium can no longer be detected.

### Example 2: Production of LiCₓ (x=6−12) from Synthetic Graphite SLP 30 and Si-coated Lithium in a Planetary Ball Mill

Under a protective gas atmosphere (argon-filled glove box), 5.00 g of synthetic graphite powder SLP30 from the Timcal Company as well as 0.529 g of Si-coated lithium powder (production according to WO2013/104787A1) with an average particle size of D₅₀=56 μm (measurement method:

laser reflection, device Lasentec FBRM of the Mettler Toledo Company) were filled into a 50 ml grinding cup of zirconium oxide and were mixed using a spatula. Subsequently, approx. 27 g of zirconium oxide grinding balls (ball diameter 3 mm) were filled in. The mixture was ground in a planetary ball mill (Pulverisette 7 Premium Line of the Fritsch Company) for 15 minutes at a rotation frequency of 800 rpm.

The ground product was screened in the glove box, and 4.9 g of a black, pourable powder were obtained.

It can be shown using X-ray diffraction analysis that lithium intercalation took place; however, unchanged graphite can still be detected. By contrast, elementary or metallic lithium can no longer be detected.

### Example 3: Stability of the Lithiated Synthetic Graphite from Example 1 in Contact with NMP as well as EC/EMC

The examination of the thermal stability was carried out using an apparatus of the Systag Company, Switzerland, the Radex system. To this end, the substances or substance mixtures to be examined were weighed into a steel autoclave with a capacity of approx. 3 ml and were heated. Thermodynamic data can be derived from temperature measurements of the oven and of the vessel.

In the present case, 0.1 g of Li/C mixture or compound with 2 g of EC/EMC were weighed in under inert gas conditions and were heated to a final oven temperature of 250° C. The mixture of the LiC_{X} material according to the invention and EC/EMC does not begin to decompose until approx. 190° C. has been exceeded.

During mixing of the Li/C compound from example 1 with NMP, a spontaneous, however weak reaction (without any run away phenomena) will be noted. During the subsequent Radex experiment, no significant exothermic effect will be noted up to an end temperature of 250° C. The thermolysed mixture is still liquid as before.

### Comparative Example 1: Stability of Mixtures from Uncoated and Coated Lithium Metal Powder and Synthetic Graphite (Molar Ratio 1:5) in NMP as well as EC/EMC

As in example 3, mixtures from 0.09 g of graphite powder SLP30 and 0.01 g of lithium powder with 2 g of solvent were weighed into the 3 ml steel autoclave and were examined for any thermal events.

In the case of both mixtures with the highly reactive solvent NMP, clear decomposition exotherma (run away) with peak temperatures of 110-120° C. can be detected. The mixture with the uncoated powder reacts even at markedly lower temperatures than the one with the coated powder.

The thermolysed mixtures are predominantly solid or polymerised. Also the analogous mixture of uncoated lithium powder with a 1:1 mixture of EC/EMC reacts very intensively once approx. 170° C. has been exceeded.

### Example 4: Coating of a Lithiated Synthetic Graphite Powder of the Stoichiometry LiC₆, Produced According to the Invention, by Means of an LiBOB Solution in EC/EMC

4.5 g of a lithiated synthetic graphite powder, produced according to example 1, were mixed in a glass flask under an argon atmosphere with 10 ml of a 1% LiBOB solution (LiBOB=lithium bis(oxalato)borate) in anhydrous EC/EMC (1:1 wt/wt) and stirred for 2 hours at room temperature. Subsequently, the dispersion was filtered in the absence of air, washed three times with dimethyl carbonate and once each with diethyl ether and hexane. After drying under vacuum for 3 hours at room temperature, 4.3 g of a gold-glimmering dark powder were obtained.

### Example 6: Stability of the Coated Product from Example 4 in EC/EMC and NMP

The coated material from example 5 and a sample of the untreated lithiated graphite powder (production analogous to claim 1) were examined in the Radex apparatus for thermal stability in the presence of an EC/EMC mixture.

The uncoated material begins to decompose as early as from approx. 130° C., whereas the coated powder does not exothermically react until above approx. 170° C.

During mixing with NMP, no reaction is noted at room temperature. In the Radex experiment, very weak exotherma were registered only from approx. >90° C.

The mixture remains liquid.

### Example 7: Production of LiCx (x=12) from Synthetic Graphite SLP 30 and Si-Coated Lithium in a Planetary Ball Mill and Stability in NMP

In the mill described in claim 1, 5.00 g of synthetic graphite SLP 30 and 0.26 g of uncoated lithium powder were ground for 30 minutes at 800 rpm. 4.8 g of a black, pourable powder were obtained. If mixed with NMP, no significant results are registered in the DSC experiment with the Radex apparatus.

1-19. (canceled)

20. A method for producing a (partially) lithiated synthetic graphite, the method comprising
lithiating, in a non-electric manner, a synthetic graphite powder with a lithium metal powder to produce the (partially) lithiated synthetic graphite;
wherein the lithiating is brought about by stirring, grinding, and/or compressing the synthetic graphite powder and the lithium metal powder at an ambient pressure of not greater than 10 bar.

21. The method according to claim 20, wherein the synthetic graphite powder has an I_{D}:I_{G} ratio, determined by Raman spectroscopy, of at least 0.2.

22. The method according to claim 20, wherein the lithium metal powder and the synthetic graphite powder have a molar ratio of Li:C between 1:3, and 1:600.

23. The method according to claim 20, wherein the lithiating is carried out in a temperature range between 0° C. and 180° C.

24. The method according to claim 20, wherein the lithium metal powder is a coated or uncoated lithium metal powder with an average particle size between 5 μm and 500 μm.

25. The method according to claim 24, wherein the lithium metal powder is an uncoated lithium metal powder having a lithium content of at least 99% by weight.

26. The method according to claim 20, wherein the synthetic graphite powder is in the dry condition during grinding.

27. The method according to claim 20, wherein the grinding of the synthetic graphite powder and the lithium metal powder is carried out in the presence of an inert fluid, wherein the fluid has a weight ratio that does not exceed that of the synthetic graphite powder and lithium metal powder.

28. The method according to claim 20, wherein the lithium metal powder has a sodium content of no greater than 200 ppm.

29. The method according to claim 20, further comprising coating the (partially) lithiated synthetic graphite with at least one coating agent capable of forming an artificial SEI on the graphite surface to improve handling and for further reducing irreversible losses.

30. The method according to claim 29, wherein the at least one coating agent is selected from the group consisting of: N₂, CO₂, CO, O₂, N₂O, NO, NO₂, HF, F₂, PF₃, PF₅, POF₃, carbonic acid esters, lithium chelatoborate solutions, sulphur organic compounds, nitrogen-containing organic compounds, phosphoric acid, organic phosphorus-containing compounds, fluorine-containing organic and inorganic compounds, and silicon-containing compounds.

31. The method according to claim 20, wherein the synthetic graphite powder has an I_{D}:I_{G} ratio, determined by Raman spectroscopy, of at least 0.5.

32. The method according to claim 20, wherein the lithium metal powder and the synthetic graphite powder have a molar ratio of Li:C between 1:5 and 1:600.

33. A galvanic cell containing, in the charged condition, the (partially) lithiated synthetic graphite produced according to claim 21.

34. A galvanic cell, containing the (partially) lithiated synthetic graphite according to claim 22.

35. A method for producing a lithium battery anode, the method comprising:
forming a dispersion by mixing.
(A) a (partially) lithiated synthetic graphite powder;
(B) at least one binder material;
(C) optionally one or more further materials in powder form, which are capable of intercalating lithium, with an electrochemical potential 2 V vs Li/Li⁺;
(D) optionally an additive for improving conductivity; and
(E) a non-aqueous solution;
applying the dispersion to a collector foil using a coating method, and;
drying the current collector having the dispersion on its surface.

36. The method according to claim 35, wherein the mixture comprises one or more further materials in powder form selected from the group consisting of: graphite, graphene, layer-structured lithium transition metal nitrides, metal powder capable of alloying with lithium, main group metal oxides with a metal that alloys with lithium in the the oxidation stage zero, metal hydrides, lithium amide, lithium imide, tetralithium nitride hydride, black phosphorus, and transition metal oxides that are capable of reacting with lithium according to a conversion mechanism under absorption of lithium.

37. The method according to claim 35, wherein the non-aqueous solvent is selected from the group consisting of hydrocarbons, N-methyl-pyrrolidone, N-ethyl-pyrrolidone, dimethyl sulfoxide, ketones, lactones, cyclic ethers, and any combination thereof.

38. The method according to claim 35, wherein the binder is selected from the group consisting of polyvinylidene fluoride, Teflon, polyacrylates and polyisobutenes.

39. The method according to claim 20, wherein the lithiating is carried out in a temperature range between 20° C. and 150° C.

40. The method according to claim 28, wherein the lithium metal powder has a sodium content of no greater than 100 ppm.

41. The method according to claim 40, wherein the lithium metal powder has a sodium content of no greater than 80 ppm.
